(19) United States
(12) Patent Application Publication
(10) Pub. No.: US 2023/0230190 A1
(43) Pub. Date: Jul. 20, 2023

(54) PERSONAL PROTECTOR PLATFORM

(71) Applicant: CLICKNOW TECHNOLOGIES LTD, Kfar Sabba (IL)

(72) Inventor: Michal Hubschmann Rahamim, Kfar Saba (IL)

(73) Assignee: CLICKNOW TECHNOLOGIES LTD, Kfar Sabba (IL)

(21) Appl. No.: 18/156,352

(22) Filed: Jan. 18, 2023

Related U.S. Application Data
(60) Provisional application No. 63/266,906, filed on Jan. 18, 2022.

(51) Int. Cl. G06Q 50/26

(52) U.S. Cl. CPC G06Q 50/265

(57) ABSTRACT

There may be provided a method for personal protection, the method may include sensing information regarding a person; determining, by an artificial intelligence (AI) process, and based, at least in part, on the information regarding the person, whether the person is in risk; and triggering one or more threat mitigation operations or performing the one or more threat mitigation operations when determining that the person is in risk, wherein a threat mitigation operation may include alerting one or more risk mitigation entities.

### BACKGROUND

Each week, around 50 women in the EU lose their lives to domestic violence while a large chunk of the women fear travelling alone in the streets especially in night. Under reporting is also a major problem with only 30% of victims reporting their physical attack & 11% their incident of harassment to the police. The safety level of the general population is very low, and it is continually decreasing in spite of the constant increase in the number of security cameras.

Most if not all solutions today focus on intervention only. Products from Google/Apple just offer the capability to track location of family members, while some start-ups, that have emerged in the personal security arena are either too expensive (€50-100/month/user), putting them out of reach for most of our only suitable for only certain scenarios.

Current personal protection solutions range from personal bodyguards, which are too expensive, to software solutions such as SOS buttons in smartphones, which are of limited use.

Existing solutions for personal protection can be classified into two main categories: inbuilt features in Android/iOS platform which allow for creation of family groups (friends & family groups as protectors for tracking the location while they set the timer ON) for tracking the location of a person's device and more sophisticated platforms such as SayVu, Carbyne, OurBond, & SafeUp.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a PPH and its environment;

FIG. 2 is an example of a PPH and its environment;

FIG. 3 is an example of a scenario;

FIG. 4 illustrates an example of a method; and

FIGS. 5-11 illustrate examples of screen shots of secnarios.

### DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There may be provided a PPP (Personal Protector Platform). It is a Smart Personal and Social Safety and Security Platform designed to provide warnings, create deterrence, and allow for prevention and effective Intervention in cases of violence and crimes.

The PPP may use bots that may be executed by user device(s) such as smartphones or wearable items, that may be in communication with cloud computers or any other computational devices. Alternatively—the PPP may be implemented by the user device(s) alone. The PPH may include a stand alone mode in which the PPP is implemented by the user device(s) alone and may include another mode in which the PPP is implemented by the user device(s) and another computerized system.

Any reference to a smartphone may be applicable mutatis mutandis to a user wearable device—for example a bracelet, a smartwatch, a smart article of clothing, and the like.

The PPH may apply bot-based tracking, auto-risk classification, image analyses and sharing, etc., which make it extremely suitable for personal safety applications.

PPP may provide a large-scale positive impact by approaching the problem more effectively by using both prevention & intervention.

The cost-effective solution comprises top-notch technologies to allow three main functionalities:

(1) Automatic risk analysis through an AI based algorithm, (2) Machine learning-based organization of visual data of the users, automatically adapted to authorities' preferences, & (3) An interactive AI based audio bot which is able to keep track of the wellbeing of the user.

Currently is seems that there is no other technology has a similar suite of capabilities which uniquely enables PPP to respond to any adverse condition.

The PPP may be viewed as a social platform that provides a comprehensive answer to a broad range of personal safety challenges.

The PPH has two functionalities:

1) Prevention: The PPH may use an AI based bot that is able to identify any risky situations being faced by the user. This may be achieved through analyzing imagery and sounds through user's own smartphone camera and microphone and real-time news and information about user's location. The level of risk to the user is thus classified and intervention actions can be performed. The analysis may be made by the user device(s) or by another computerized system.

2) Intervention: The PPH may include one or more communication devices (for example a Advanced Community Management System) which are able to share relevant details of the user (location, time elapsed in the risky zone, imagery) with the authorities, community level safety officers & family members. The one or more communication devices may include the user device(s) itself, or may include any communication elements configured to communicate between the user device(s) and any relevant entity (for example the police, and the like). Any communication protocol can be used.

The PPH may sense signals, the signals may be analyzed (for example by applying one or more AI processes) to detect events of interest—or detect a potential occurrence of an event of interest (such as potential threats), and one or more predefined responses can be performed—based on the detection.

Any reference to an event should be applied mutatis mutandis to a potential occurrence of the event.

One or more responders of interest may be defined—and the one or more predefined response may include communicating with one or more responder or interest, generating an alert, inducing a responder of interest to respond (for example perform an emergency call to the police), after receiving an indication about an occurrence of an event of interest. The responder of interest may be defined by the user or by another party.

Different events may be associated with different responder(s) or interest. For example a user may decide to send an alert to a family member when one event occurs and may alert the police when another event occurs.

End-users may benefit as PPP will grant them a means of protecting themselves and offer them the highest level of safety. Women and other people such as teenagers and older people who have a greater chance of being part of a crime and are unable to protect themselves will for the first time have help available at the tip of their fingers.

Organizations and corporate will benefit from an improved safety level of their employees. Apart from increasing the attractiveness of the employer to potential employees, the adoption of PPP will also lead to improved profits as estimates have shown that for every euro invested in occupational health and safety, the return for the employer is around twice as much. Moreover, for some jobs such as journalism, the EC is working on new guidelines on improving the safety of these workers and thus solutions like PPP will act as a force multiplier for increasing their safety.

The PPP overcomes some of the deficiencies of prior art solutions such as a lack of real-time interaction with a timer-based bot and do not allow for creation of sub-protector groups by the user. Most solutions fail to offer voice recognition capabilities to ensure the identity of user and avoid the impostor. Other solution may not allow live video chatting with a central command control for immediate support. Various prior art solutions fail to act as a content management platform for violent occurrences for the authorities and none of prior art solution uses an advanced, auto-risk classification AI.

The present solution , in some embodiments thereof, relates to searching and optionally receiving knowledge base of violent occurrences Insights using a Personal Protectors Platform (PPP) a user interface, and, more specifically, but not exclusively, to searching and optionally violent occurrences map of insights using a Bot interface that collect the data from the Wisdom of the multitude filed to better understand the high level of geolocation and, effective prevention and intervention layer.

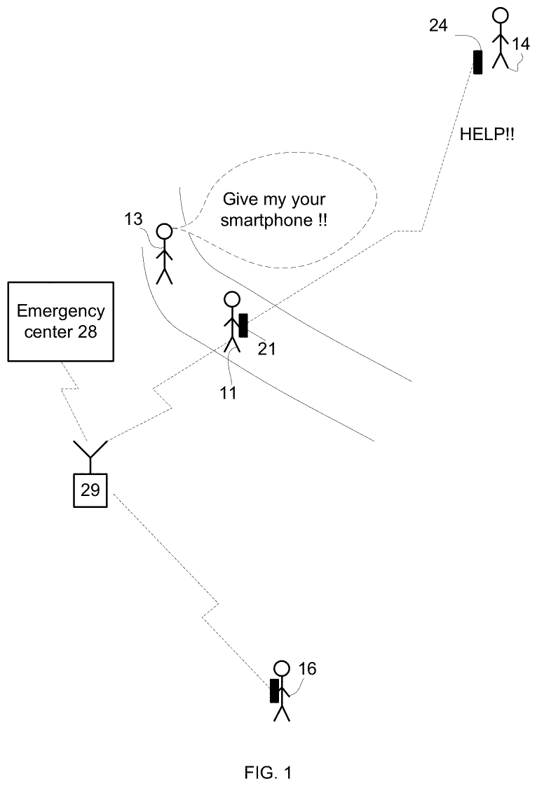

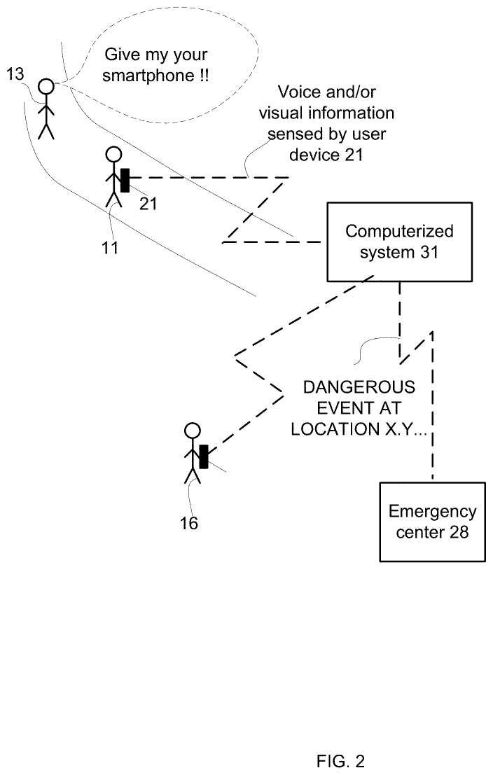

FIGS. 1 and 2 illustrate a user 11 having a smartphone 21 (part of the PPH) that faces a dangerous event—another person 13 shouts that he wants to take the smartphone 21 of user 11. In FIG. 1 the smartphone 21 itself (for example by executing a bot) determines that the user is threatened and notifies (sends HELP alerts) to protector 14 (via smartphone 24), to another protector 16 and also communicated with a relay or a communication device that transfers the alert to an emergency center 28. In FIG. 2 the smartphone 21 does not detect the threat—but sends voice and/or visual information is sensed to a computerized device 31 (may be a server, a cloud computer and the like) that in turn detects the threat (based on the voice and/or visual information) and send a dangerous event (at a certain location) to the person 16 (to his user device) and to emergency center 28. Any type of alert and/or response may be provided. Any type and/or number of protectors may be provided in each scenario.

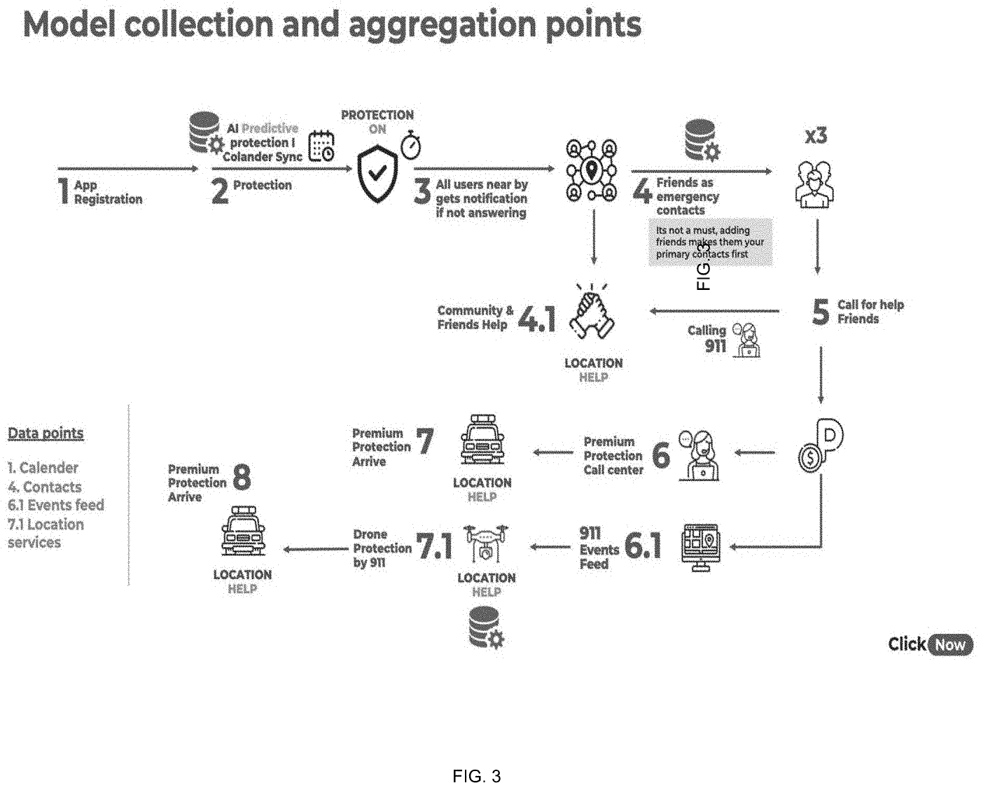

FIG. 3 illustrates a scenario that includes registering a user to the application, applying protection (determining an occurrence of a threat) and notifying various elements (such as nearby users, predefined protectors (such as family members, friends), emergency centers, and the like. The protectors may assist in disarming the thread and/or validating or invalidating the threat. The validation and/or neutralization of the threat may require the assistance of humans and/or devices such as sensors (activating sensors at an area of the threat), drones that are directed towards the thread and acquire images that can be used by a protector to validate the threat, and the like. A drone or other devices of system may be used to neutralize the threat, communicate with the aggressor, and the like.

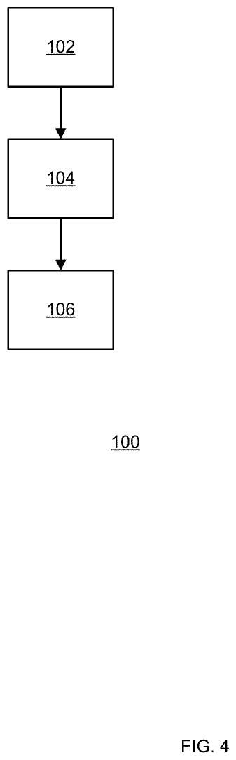

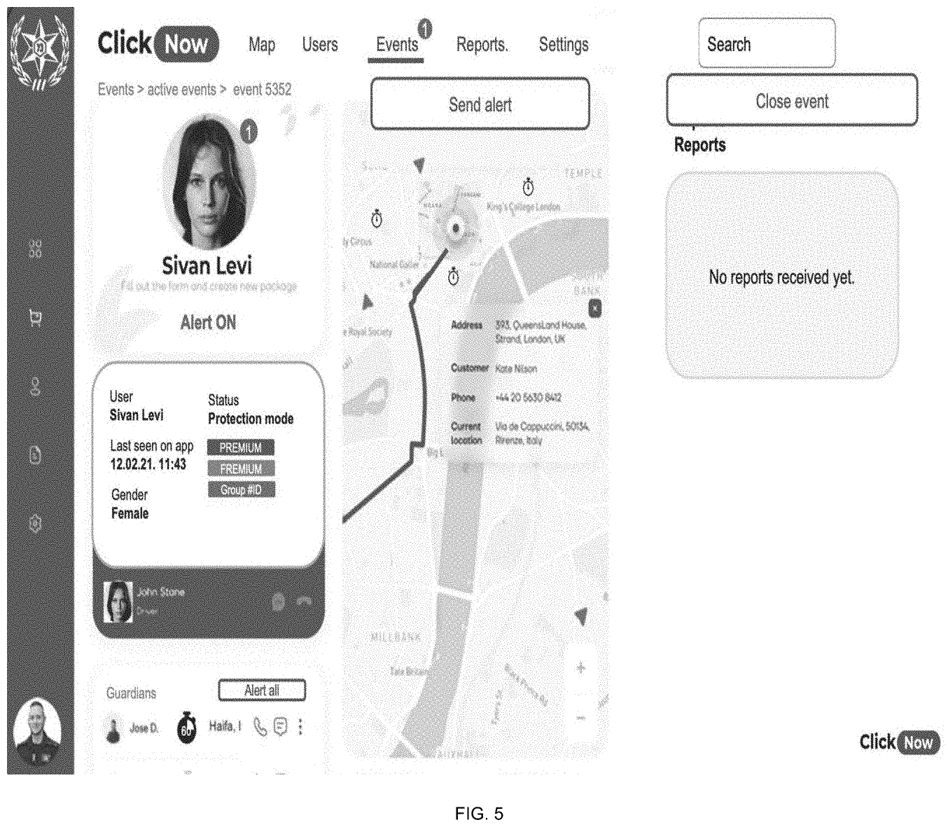

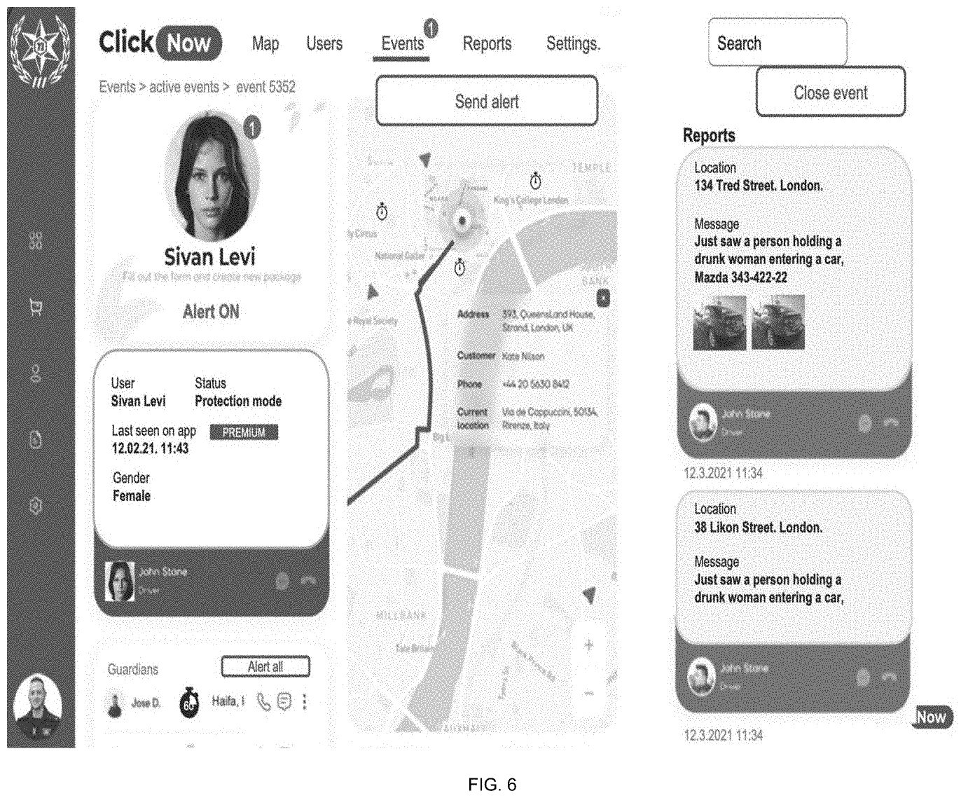

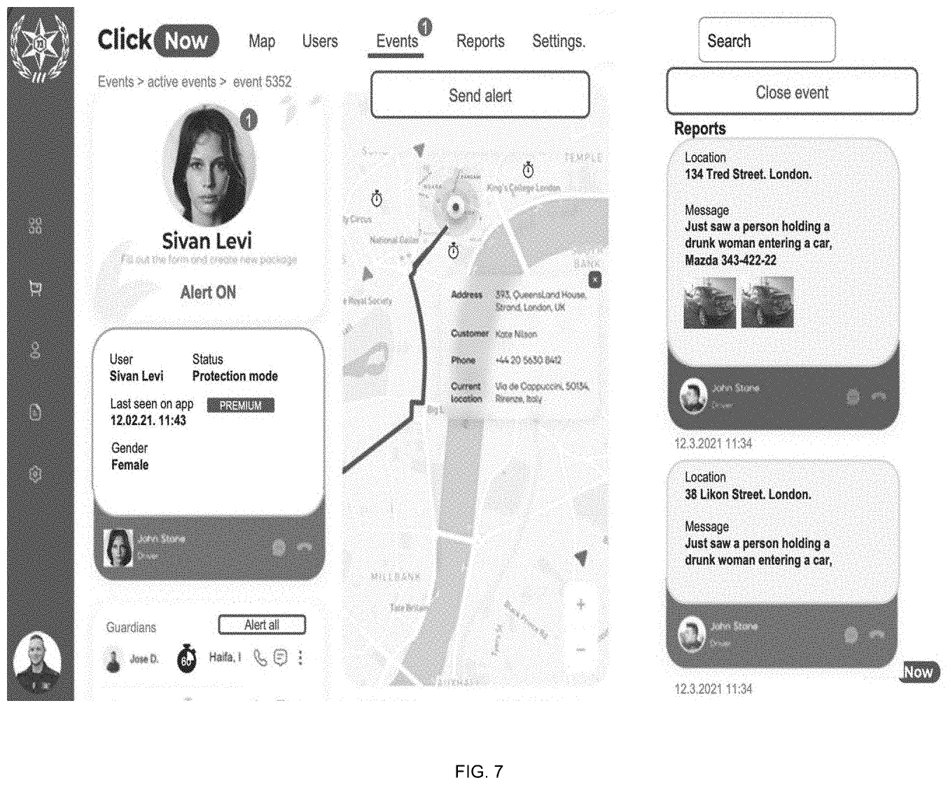

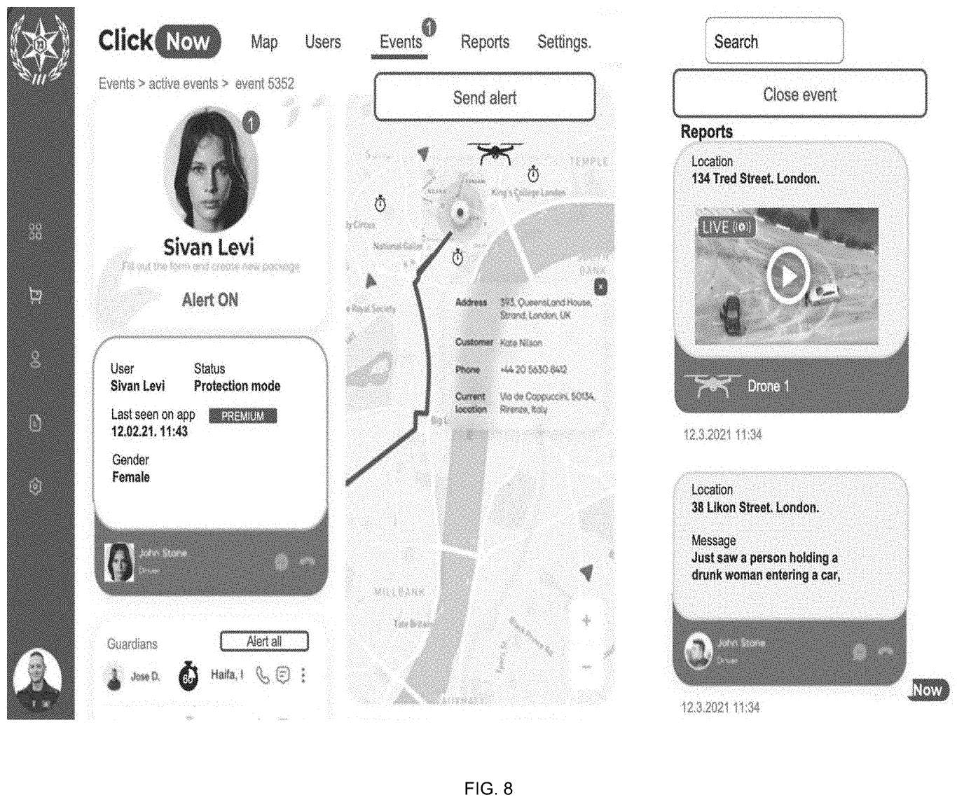

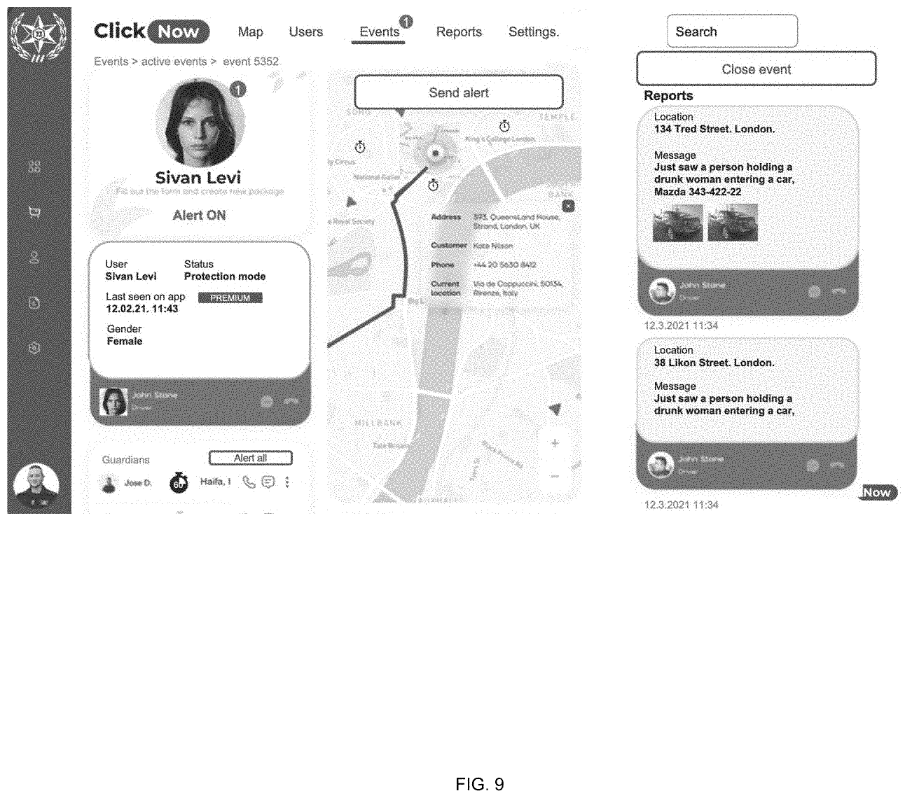

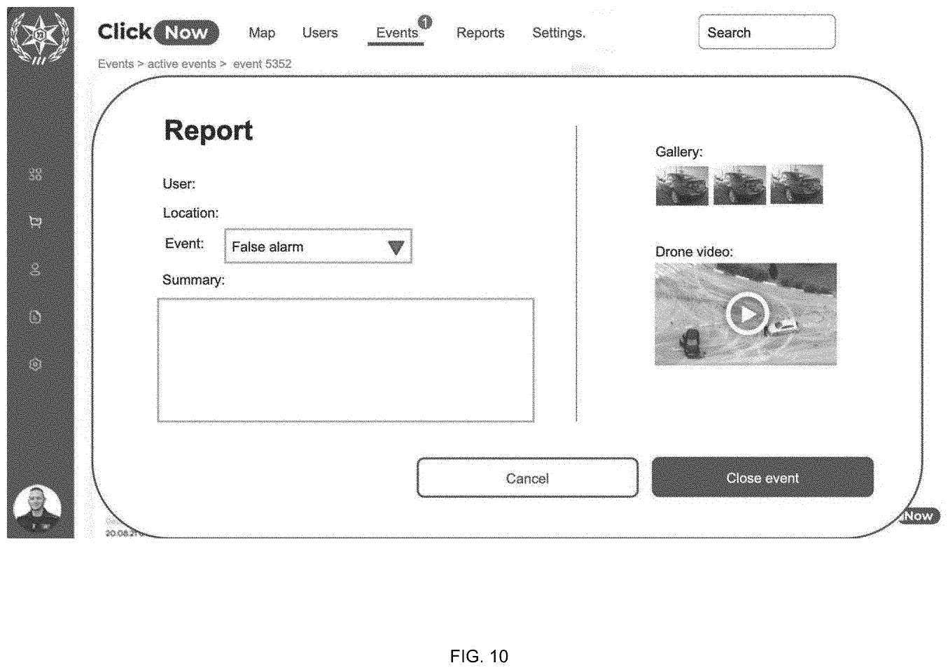

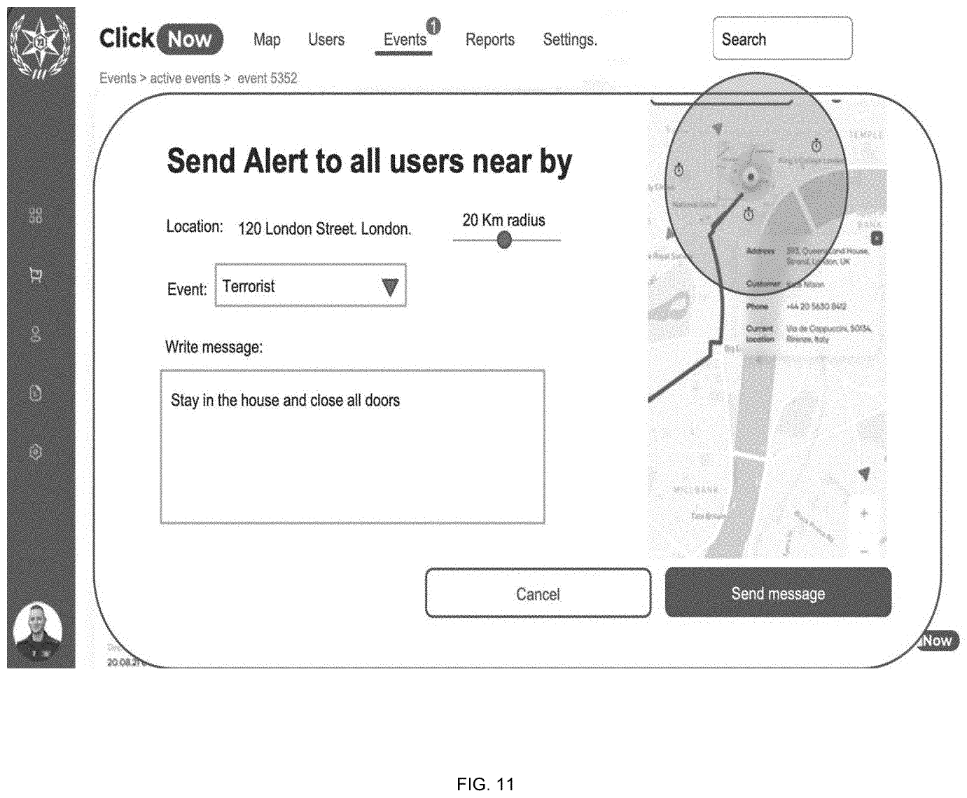

FIG. 4 illustrates an example of method 100.

There may be provided a method for personal protection, the method may include (102) sensing information regarding a person; determining (104), by an artificial intelligence (AI) process, and based, at least in part, on the information regarding the person, whether the person is in risk; and triggering one or more threat mitigation operations or performing the one or more threat mitigation operations (106) when determining that the person is in risk, wherein a threat mitigation operation may include alerting one or more risk mitigation entities.

The method may include validating the risk by activating sensors located in a vicinity of the person.

The method may include validating the risk by sending a drone to sense the person and an environment of the person.

The method may include communicating with a potential aggressor that is suspected to threaten the person.

The method distributing information regarding the risk and a location of the person to protectors that are located within a vicinity of the person.

The method may include verifying an identity of the person using at least one out of visual verification and voice verification.

The determining of whether the person is in risk is also based on a location of the person and a history of hazardous events associated with the location of the person.

The determining of whether the person is in risk is also based on a deviation of a behavior of a person from an expected behavior pattern of the person.

The method, may include monitoring a behavior of a person at multiple points in time to provide monitoring results, and wherein the determining of whether the person is in risk is also based on the monitoring results.

The monitoring may be executed by an interactive AI bot.

The method may include organizing the information regarding the person on a predefined format that is compatible to law enforcement requirements.

The method may include monitoring a progress of execution of the one or more threat mitigation operations.

The PPP may provide human & AI bodyguards anywhere, anytime to anyone in the fastest and most effective way.

A user is able to set responders of interest such as but not limited to protector groups (family, friends & friends, authorities, etc.) to monitor and respond to any incident that could be potentially unsafe. The user can set a timer that they can activate as they enter into an elevated risk zone. The main values generated for the user are:

1) Elevated security: The AI Audio Bot periodically generates questions during the virtual protection time to check the safety level of the user. Automatic decision making: The algorithm forms the in-built command control (plug and play). Once the AI identifies a high-risk level, is starts calling the pre-selected protectors.

2) Improved response time: Through automatic risk & image analysis, authorities are alerted with relevant information while The Prevention, Intervention, and Protection Window is still open—(PIP Window/PIPW). The user may also set the frequency in advanced choosing if we want to check his safety every 10 m, 20, 30, 1 h—alternatively the frequency may be determined automatically.

The PPP allows real-time interaction with an AI powered, timer-based audio bot which allows for fast communication with the protector groups and authorities. Furthermore, PPP may be configured to perform image processing for automatic tagging of picture content, attribute correlation, image data transfer and machine learning technology to reorganize the visual assets according to tags, location, image recognition & user data. This not only allows the algorithm to auto classify the risks faced by the user but also organizes 2D and 3D imagery and match it to the preferences to maximize effective data sets for the decision-makers (authorities).

The detection of events of interest and/or the determination of which predefined responses to execute and/or the execution of the predefined responses may be defined in various manners—for example may be based on AI processes and/or may be based on rules.

### Examples of Rules

Examples of rules are provided below:

Rules variables may include:

A—User journey and the bot identify risk , we keep geo location and geo coordinators.

B—Wisdom of the multitude occurrences based on our users history.

C—Public knowledge API Police distance from the user.

D—Public knowledge API dangerous geo location level 1-10.

E—Users protectors data base location.

F—Fales events.

G—Civil cameras coordinators.

H—User location

H1—10+ event in “H” location.

H2—5-10 event in “H” location.

H3—1-5 event in “H” location.

I—Protectors location.

J—Numbers of protectors on each zone

K—Private Protection common control.

L—friends and family group

N—Community group

M—Advanced trained Community group

Rules

Rule 1—The user Open the Protection timer to suggest the risk level the user when checking:

H=B+D−F

The suggestion will be notification of opening the protection alarm as the user is in a dangerous Location, the risk level from 1-3, 1 is the highest.

1=10+event in “H” location

2=5-10 event in “H” location

3=0-5 event in “H” location

Rule 2: Calculate the time of rescue estimation in case event formula:

H=“C” coordinate from the user location, +“I” coordinate from the user location , if the result are+“J”:

H=C & I=between 0 km-2 km+2+“J”=3-7 minutes estimation

H=C & I=between 1 km-2 km+5+“J=5-10 minutes estimation

H=C & I=between 2 km-5 km+3+“J=10 minutes+estimation

H=C & I=between 5 km-10 km+3+“J=13 minutes estimation

H=C & I=between 10 km-2+“J=20+ minutes estimation

H=C=10 km+& 2 “J”+“I”1 km-2 km”=3-7 minutes estimation

H=C=10 km+& 0 “J”+“I“1 km-2 km”=30 minutes estimation

Rule 3: The user will get suggestion witch Protector type he should reserve in this location:

Ones H1 the engine suggest K+L+N+M

Ones H2 the engine suggest M+K

Ones H3 the engine suggest L+N

### More About the PPH

The solution may use a “Bot Protection”—The Wisdom of the multitude machine Learning-based during the Protection and violent occurrences

Using the algorithm, we gain insights based on the big data we collect—below are the details.:

3 Main Insights
When you must open the Protection timer
Risk level at thus location
calculate the time of rescue in case event

When the user opens the application, he will be able to calculate the risk based on this data and decide if he should activate the protection based on the recommendation.

The potential risk level for the types of violent occurrences is based on location, In the event of an occurrence, the estimated time of arrival to the victim is determined by the location, Specify the type of protectors, and suggest an alternative route.

The parameters:

User Profile, behavior, protectors

User Profile: gender, age—on this data we are building the *“experiences” of the user and adding the Wisdom of the multitude analyze

Saved in the system the type of protectors that the user has defined:

1—Private circle=friends and family from the user contact

2—Community=civilians in 3 km distance

3—Command control=professional command control

Phone data,—we adding quality level to phone brand, version, and the types from 1-3 we add this to the in the database (its the quality may be of the camera of the phone version)

Location—location of the user

The location set in the database in advanced as a “risk level” from 1-10 based on open-source data that is open to the public—such as but not limited to police reports regarding crimes per areas, and the like.

Location of police stations

Based on public knowledge of the geo we keep them in the data base

Wisdom of the multitude occurrences

We collect data about the occurrences of the users—for example mapping the civilian cameras in a city so ones there is an event we can send immediate order for the police to open that camera that close to the user , as we have his location and we can point the closest civilian cameras fast. The data when they open the bot protection: walking, running, dark, light day, meeting, parties. car driving, hour, how much time it took to arrive to the location, the type of the event.

the falls alarm

Civil cameras

We create a map of a civilian camera and/or any other sensors and keep it in the database based

on public Knowledge

False alarms

We keep all the FALSE alarm occurrences and we relate them to the following parameters:

Location of the Protectors

We keep in the database the location of the protectors

How the build a decision?

Parameter A—: the bot is questioning the user if he is still safe

The user is not responding in 5-second

Camera is open from the device

Voice is Open for the device

Parameter B—voice shouting

The user is not responding in 5-second

Camera is open from the device

Voice is Open for the device

Parameter C—Phone Shaking

The user is not responding in 5-second

Camera is open from the device

Voice is Open for the device

We train the system to recognize violent accuracies by learning a certain number (for example 50) types of content and learning a certain number (for example 50) voice types of silent.

User Profile, behavior+Phone data+Location+Wisdom of the multitude−false alarms occurrences+Location of the Protectors+type of the protectors+The user is not responding+camera content analyse+voice analysis+civilians camera in the location+Location of police stations

The bot is taking the decision to open event in any case while the user is not responding to the safety Rules, the insights we get based on the process is:

Insight A—The risk level for occurrence (each time timer is on)

Insight B—The estimate time arrive to the victim

Insight C—Potential locations for risk level for occurrence

Insight D—Recommendation engine: Locations Timer activation for the user

what type of protectors to set

Insight E—Suggestion of alternative route

The PPH may collect data in various manners—for example collect meta data from the images and video, recognition process of the media.

The PPH may detect events of interest and preform a predefined response in real time—for example within less than a second—for example within one millisecond, and the like.

The PPH may apply speech recognition, real-time on-device shake recognition, neural networks, data analyses and classification, machine learning & software development.

One's event begin the phone camera and the record is opened to the defined group.

The Audio Bot may generates questions during the virtual protection time to check the safety level of the user.

The PPH may utilize a speech recognition feature to ensure the identity of the user and avoid the imposters. Once the AI Audio Bot identifies a high-risk level through the risk assessment algorithm, it can take intervention actions such as calling the authorities, alerting family groups.

The PPH may use a Personal Behavior Device Profile is created for the user based on their behavior and interactions with the phone. It can also take into account their health data such as normal heart rate, Spo2 level from any wearables worn by the user.

The PPH may utilize image processing for automatic tagging of picture content, attribute correlation, image data transfer and machine learning to reorganize the visual assets according to the data provided through GPS.

The PPH may use an architecture for data management that will allow the PPH to prioritize what is real-time, what is for evidence & recommending and alerting authorities based on the level of the risk situation.

Additional examples, scenarios, rules, processes, user interface details are listed below:

Active Protection—geo fencing

a. Users should be able to disable the active protection state (when it is active) within the active protection screen (one with the timer). The protection rules will not be triggered (the geofence should be ignored) until the user manually enables the protection again.

b. A local notification (after x time) can be generated to remind the user to enable the protection triggering in case it is disabled.

Tracking Locations
When protection is on—sending location every 1 minute.
When event is on—the system many send location every 1 minute to user.
An active guardian may send the location every 1 minute to user
An active guardian can submit a report and/or be done with the event without rejection, before event is resolved. Guardian should be able to choose to turn off location tracking when is no longer relevant.
Update the map with current location, fetch other party location each minute and update the map.

### Communications

a. Everyone who accepts help gets into a chat room.
b. The chat is active as long as the event is active. Once the event is closed, you cannot initiate any call.
c. Everyone can write in the chat room.
d. Everyone can upload photos and videos. They will be in the form of a report.
e. Everyone can initiate a video or audio call with the ward.
f. There can be only one active video/audio at a time per chat
g. Ward can initiate a video or audio with anyone on the chat. One at a time.

Guardians may be a white label mobile application targeted to support the personal safety of individuals by leveraging the power of others as well as the power of organizations.

Minimal viable product scope:

The first release of the application will include
a cross platform flutter app to run on iOS and Android and will be released to their stores.
A web interface to support organizations that will monitor their members for help.
A server application to support the code features of the app.
1. A user will receive an invitation by email and/or SMS to onboard the mobile app.
2. The user will be redirected to install the mobile app from the store.
3. A user will experience a get started Wizard and will register by sms validation and will fill mandatory personal info
4. A user will give permission to the app to access contacts locally and the app will allow selection of invitees to serve as guardians.
5. Each invitee will receive an SMS and email (if exists) inviting to accept being a guardian for the user. The URL will try to open the app and if doesn't exist, will route to the appstore to install.
6. Once app opens and guardian registers with the phone number, the accept open to be a guardian for user will be available and guardian will need to confirm.
7. A user will have a button to start protection
8. Options for protection:

For X amount of time

As long as user is within a range distance from a location or current.

As long as user doesn't reach a target location (within range distance)
9. A user will have to confirm “all good” state according to the scheduled metrics originally defined.
10. If user does not respond within a certain threshold of time, an event is getting triggered.
11. Once event is getting triggered, the guardians within an order, will get a notification about the event, a location of user will be exposed to guardian with option to accept the help.
12. If accepted a chat will be opened between guardian and user.
13. A navigation option will be open for guardian through any installed 3rd party navigation app for the guardian to choose from (standard open with option).
14. The guardian as well as the user will have the ability to make a call to each other.
15. The guardian will be able to cancel the help or to acknowledge the finalization of the event (help given)
16. If guardian cancels the help, the help will be assigned to next guardian
17. If guardian acknowledges the finalization of the event, an option to fill a report will be given to the guardian.

Personas:
Family—parents<>children and children<>children
   Push notification sound—not intrusive
   Parent defines automatic protection
   Parent defines suggestion for turn on notification—push notification and suggestion
   Define safe zones with marginal radius
   Define dangerous zones with marginal radius
Women
   Manual turning on protection
Elderly
Define Protection Rules—part of the onboarding process
   Name
      My rules—list them
      Sport
      Dating
      Walking in dangerous zone
      Travel
      . . .
      Custom+add new event name
      Ability to change the name
   Locations
   Rule type:
      Safe to Safe—exit safe zone until enter a safe zone
      Enter dangerous zone
      Time—how long is the protection for
      Phase 2: Start—End time—recurring.
   Confirmation rule
      Every X time including never
      On arrival to location
   Apply to guardian
      Protection for me—default
      Protection for one of my protected
   Actions
      Start now—temporary
      Save as Protection Rule—permanent
Location:
   Address
   Radius
   isSafe
Event created on non response
   Call to first private guardian
   Call to closest community guardian
   Tracking of distance between the 2 people
      If distance does not change for X time, confirmation back to users if they still need help
      Option to skip to next guardian
      Every X time, notify both the updated distances between 2 help
   Event—today we will have only 2 people. In the future we may have more people.
Onboarding event types and guardians list
   Guardians can be people I guard and people that will guard me

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices.

Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals. Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality. Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components.

Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for personal protection, the method comprises:
sensing information regarding a person;
determining, by an artificial intelligence (AI) process, and based, at least in part, on the information regarding the person, whether the person is in risk; and
triggering one or more threat mitigation operations or performing the one or more threat mitigation operations when determining that the person is in risk, wherein a threat mitigation operation comprises alerting one or more risk mitigation entities.

2. The method according to claim 1 comprising validating the risk by activating sensors located in a vicinity of the person.

3. The method according to claim 1 comprising validating the risk by sending a drone to sense the person and an environment of the person.

4. The method according to claim 1 comprising communicating with a potential aggressor that is suspected to threaten the person.

5. The method according to claim 1 distributing information regarding the risk and a location of the person to protectors that are located within a vicinity of the person.

6. The method according to claim 1 comprising verifying an identity of the person using at least one out of visual verification and voice verification.

7. The method according to claim 1 wherein the determining of whether the person is in risk is also based on a location of the person and a history of hazardous events associated with the location of the person.

8. The method according to claim 1, wherein the determining of whether the person is in risk is also based on a deviation of a behavior of a person from an expected behavior pattern of the person.

9. The method according to claim 1, comprising monitoring a behavior of a person at multiple points in time to provide monitoring results, and wherein the determining of whether the person is in risk is also based on the monitoring results.

10. The method according to claim 9, wherein the monitoring is executed by an interactive AI bot.

11. The method according to claim 1, comprising organizing the information regarding the person on a predefined format that is compatible to law enforcement requirements.

12. The method according to claim 1, comprising monitoring a progress of execution of the one or more threat mitigation operations.

13. A non-transitory computer readable medium for personal protection, the non-transitory computer readable medium stores instructions for:
sensing information regarding a person;
determining, by an artificial intelligence (AI) process, and based, at least in part, on the information regarding the person, whether the person is in risk; and
triggering one or more threat mitigation operations or performing the one or more threat mitigation operations when determining that the person is in risk, wherein a threat mitigation operation comprises alerting one or more risk mitigation entities.

14. The non-transitory computer readable medium according to claim 1 that stores instructions for validating the risk by activating sensors located in a vicinity of the person.

15. The non-transitory computer readable medium according to claim 1 that stores instructions for validating the risk by sending a drone to sense the person and an environment of the person.

16. The non-transitory computer readable medium according to claim 1 that stores instructions for communicating with a potential aggressor that is suspected to threaten the person.
